(19) United States
(12) Patent Application Publication
(10) Pub. No.: US 2014/0036435 A1
(43) Pub. Date: Feb. 6, 2014

(54) STORAGE SYSTEM HAVING A HEATSINK

(71) Applicant: MOSAID TECHNOLOGIES INCORPORATED, Ottawa (CA)

(72) Inventor: Jin-Ki KIM, Ottawa (CA)

(73) Assignee: MOSAID TECHNOLOGIES INCORPORATED, Ottawa (CA)

(21) Appl. No.: 13/800,897

(22) Filed: Mar. 13, 2013

Related U.S. Application Data
(60) Provisional application No. 61/679,244, filed on Aug. 3, 2012.

(51) Int. Cl. G06F 1/20

(52) U.S. Cl. CPC G06F 1/20
USPC 361/679.33

(57) ABSTRACT

A storage system sized to fit within a standard magnetic hard disk drive (HDD) form factor. The storage system includes a solid state disk (SSD) and a cooling means thermally coupled to the body of the SSD. The components of the SSD occupy a smaller volume of space than magnetic HDD's. In particular, while the SSD has width and length dimensions matching those of the HDD form factor, the SSD has a height dimension that is less than the HDD form factor. Accordingly, the volume of space between the HDD form factor height and the SSD height is beneficially occupied by the cooling means. The storage system can be then be used as a direct replacement for HDD as it can fit within HDD bays configured for the standardized HDD form factor.

### CROSS REFERENCE TO RELATED APPLICATIONS

This application claims the benefit of priority of U.S. Provisional Patent Application No. 61/679,244 filed on Aug. 3, 2012, the contents of which are incorporated by reference in their entirety.

### FIELD

The present disclosure relates to computer data storage systems. More specifically, the disclosure relates to a solid state storage devices.

### BACKGROUND

Applications ranging from personal computers to mass storage centers such as datacenters and cloud storage require ever increasing amounts of data storage capacity. For instance, in cloud computing, an application where user data is stored in a virtual location on the internet, it can be appreciated that with increasing numbers of users, a large storage capability is required. In personal computing applications however, consumers are looking for more compact computing systems.

The most commonly used device for storing and retrieving digital information is the magnetic hard disk drive (HDD). HDDs are housed in an industry standard form factor which fits a standard sized compartment in a computing device. Such industry standards are examples of a pre-defined size or pre-defined form factor. Often, users will upgrade their HDD by simply replacing their old HDD with a new HDD sized to fit the standard form factor housing, when more storage is required, when HDD technology has improved or when HDD failure occurs. The two most common form factors are the 3.5 inch HDD commonly used for desktop computers and the 2.5 inch HDD commonly used for laptop computers. However, other custom sized form factors can be used in specialty devices such as portable media players or in some server hardware.

During operation, HDDs produce a great deal of heat, and it is necessary to rapidly exhaust this heat in order to prevent overheating, which could potentially lead to the failure of the HDD. Many means of cooling HDDs are known in the art. For example, U.S. Pat. No. 6,233,148 discloses a HDD with a fan installed to its outside surface. U.S. Pat. No. 5,892,655,discloses the attachment of a heat dissipative plate to the exterior of an HDD body. U.S. Pat. No. 6,538,886 discloses a HDD enclosure for housing the HDD, that includes a heat sink mounted below the HDD and a fan for blowing hot air generated from the HDD through a hot air outlet. These references all disclose cooling means that are attached to the exterior of an HDD. With a cooling means attached to the exterior, the previously discussed types of HDD's will not fit within the standard sized compartment of the computing system. Hence the arrangement of these HDDs is disadvantageous as space must be created within the computer housing in order to accommodate the cooling means. This is a problem as consumers are demanding smaller and smaller computing systems, and a compact arrangement of the components of the computing device is required. Therefore, providing extra space to accommodate non-standard sized HDD's due to the addition of externally attached cooling means may not be cost effective.

However, it is not possible to configure HDDs to include a cooling means within the dimensions of a standard HDD form factor because the form factor is almost completely occupied by the mechanical and electronic components that make up the HDD (such as disk platters, motor, sensor, pick-up arm, motor controller, HDD controller, and the host interface connector). U.S. Pat. No. 7,365,938 discloses the use of heat conducting plates in combination with heat dissipating plates to dissipate heat from a HDD. However, the heat conducting plates and heat dissipating plates are thin in order to fit within the remaining space in the HDD. In addition, the heat dissipating plates have limited contact with external air. This configuration is inefficient at transferring heat and cooling the HDD.

Thus, there is a need for a compact memory storage device having a cooling means that allows for the dissipation of heat and that maintains the dimensions of industry standard form factors.

### SUMMARY

In accordance with one aspect, there is provided a storage system having a cooling means that fits within the dimensions of a pre-defined sized HDD form factor.

Disclosed herein is a storage system for a computing device characterized by a form factor no greater in any dimension than a standard HDD form factor. The storage system comprises a solid state drive (SSD) and a cooling means mounted to the SSD and thermally coupled to the SSD.

In an aspect of the present disclosure, there is provided storage system for a computing device. The storage system includes a solid state drive (SSD) and a cooling means. The cooling means is thermally coupled to the SSD, and the form factor of the SSD in combination with the cooling means is no greater than a pre-defined sized hard disk drive (HDD) form factor. In an embodiment of the first aspect, the form factor of the SSD in combination with the cooling means is defined by orthogonal dimensions a, b and c, that are less than or equal to the pre-defined sized HDD form factor orthogonal dimensions x, y and z, respectively.

In a second embodiment, the SSD includes a printed circuit board (PCB), a host interface connector connected to the PCB, a buffer memory mounted to the PCB, a controller mounted to the PCB, and at least one memory storage device mounted to the PCB. In this embodiment, SSD and the cooling means are integrated with each other as a single unit. The storage system can further include a thermal transfer medium contacting the at least one memory device and an inner surface of the SSD, such that the thermal transfer medium cooperates with the cooling means for transferring heat away from the at least one memory device.

Alternately, the SSD can include a base for supporting the PCB, at least two sidewalls extending substantially perpendicularly from the base, and a cover connected to the sidewalls, such that the base, the sidewalls and the cover form a case for housing the PCB. According to an aspect of this embodiment, a thermal transfer medium contacting the at least one memory device and the cover of the SSD is provided, where the thermal transfer medium cooperates with the cooling means for transferring heat away from the at least one memory device. According to another aspect of this embodiment, the cooling means is fastened to the cover of the SSD, and can include a thermal transfer medium between the cover and the cooling means, where the thermal transfer medium comprises thermal tape or thermal grease.

In yet another aspect of the second embodiment, the SSD includes at least two sidewalls extending substantially perpendicularly from the base to form an open cavity for containing the PCB. The cooling means is fastened to the at least two sidewalls of the SSD to cover the open cavity. A thermal transfer medium can be included for contacting the at least one memory device and the cooling means, such that the thermal transfer medium cooperates with the cooling means for transferring heat away from the at least one memory device.

In another embodiment of the present aspect of the disclosure, the cooling means includes a heat sink, which can further include a fan mounted to the heat sink. The heat sink can include a plate of thermally conductive material and a plurality of fins extending from the plate, for dissipating heat away from the SSD. In further embodiments of the present aspect, the pre-defined sized HDD has an industry standard form factor which fits a standard sized compartment in a computing device. The pre-defined sized HDD form factor includes a 3.5 inch form factor or a 2.5 inch form factor.

Other aspects and features of the present disclosure will become apparent to those ordinarily skilled in the art upon review of the following description of specific embodiments of the disclosure in conjunction with the accompanying figures.

### BRIEF DESCRIPTION OF THE DRAWINGS

Embodiments of the present disclosure will now be described, by way of example only, with reference to the attached Figures.

FIG. 1 is a diagram of a storage system according to an embodiment of the present disclosure;

FIG. 2 is a diagram of an SSD of FIG. 1;

FIG. 3 is an exploded view of a storage system according to another embodiment of the present disclosure;

FIG. 4 is a diagram of the storage system of FIG. 3 in fully assembled form, according to an embodiment of the present disclosure;

FIG. 5 is a diagram showing an alternate SSD for use with the storage system of FIGS. 1 and 4, according to an embodiment of the present disclosure; and

FIG. 6 is a diagram showing an alternate SSD for use with the storage system of FIGS. 1 and 4, according to an embodiment of the present disclosure.

### DETAILED DESCRIPTION

The present embodiments provide a storage system which addresses the dissipation of heat and maintains the dimensions of a pre-defined sized form factor, such as, for example, a standard form factor for an HDD. The storage system comprises solid state drives (SSDs), which are memory data storage devices that utilize solid state memory, typically in the form of non-volatile semiconductor memory, to store data. SSDs are becoming increasingly popular as they are less susceptible to physical shock and mechanical failure due to the absence of moving parts, and can provide faster read performance than traditional magnetic HDD's. Additionally, the storage system comprises a cooling means that is mounted to the SSD and thermally coupled to the SSD. The storage systems disclosed herein are compact and are able to dissipate heat without requiring additional space in the computing device for a separate cooing means.

As SSDs become more popular in use as mass storage media, larger storage capacity and higher performance are required in various applications such as computing devices, datacenters, clouding computing storage. As the storage capacity of the SSD grows, the number of non-volatile memory devices in the SSD increases. This is achieved by adding more memory device packages to the SSD, and/or increasing the number of semiconductor memory dies per package. For example, the number of Flash die stacked in each memory device package can include 4-dies stacked with each other in a multi-chip package (MCP), or 8-dies stacked with each other in an MCP. In addition, high performance Flash memory devices, such as DDR type Flash memory for example, are widely used in SSDs. Therefore, heat dissipation in SSDs will become a serious issue in large scale storage applications having storage media in standard form factors. For example, a datacenter includes arrays of HDD bays, each for receiving a pre-defined sized form factor HDD.

Accordingly, SSD devices are intended to be compatible with computing systems that typically use traditional magnetic HDD's. Hence they will have a physical and electrical interface compatible with the computing systems, thereby permitting simple HDD replacement for most applications. Thus, the introduction of a solid state storage system within the form factor of standardized HDD size results in an easy-to install storage device which can be quickly installed into any standardized 2.5 or 3.5 inch HDD bay, which are examples of current HDD pre-defined sized form factors.

From this point forward, a “form factor” is used to describe the physical dimensions and shape of an article. In the context of HDD's, the form factor has a rectangular box shape. For ease of explanation the embodiments are described using industry standard 2.5″ and 3.5″ HDD form factors, which are known by the size of the magnetic rotating media. For example a 3.5″ HDD form factor has the dimensions 4 in×1 in×5.75 in, and the 2.5″ HDD form factor has the dimensions 2.75 in×0.59 in×3.945 in. However, the storage systems disclosed herein can be sized to fit any industry standard form factors which are known in the art. The storage system is considered to fit within the standard HDD form factor when every dimension of the storage system is no greater than a corresponding dimension of the standard HDD form factor. For example, the storage system is characterized by three corresponding orthogonal dimensions, referred to as a, b and c, and a standard HDD form factor is characterized by three corresponding HDD orthogonal dimensions referred to as x, y and z. The storage system fits within a form factor when a, b and c are each less than or equal to x, y and z, respectively.

As previously mentioned, a standard magnetic HDD includes many components which occupy substantially the entire volume of the HDD form factor, most of which are related to operating the disk platters that store data. An advantage of the SSD is that memory devices store data, and are compact in size. For example, the total height of the printed circuit board (PCB) mounting all necessary components, including memory device packages, is approximately 0.25 inches. This is significantly shorter than the 1 inch height of 3.5 inch HDD form factor. Therefore by replacing the contents of a standard magnetic 3.5 inch form factor HDD with a PCB having memory devices mounted thereon can result in an HDD body in which about 75% of total space is empty. The embodiments of the present disclosure take advantage of this empty space of the standard HDD form factor, by replacing some of the empty space with cooling means for dissipating heat generated by the memory devices or other components on the PCB. Such a storage system thus includes an SSD portion and cooling means which together fit within the standard HDD form factor, such as 3.5 inch HDD form factor.

According to the present embodiments, a storage system is disclosed that is sized to fit within a standard magnetic hard disk drive (HDD) form factor. The storage system includes a solid state disk (SSD) and a cooling means thermally coupled to the body of the SSD. The components of the SSD occupy a smaller volume of space than magnetic HDD's. In particular, while the SSD has width and length dimensions matching those of the HDD form factor, the SSD has a height dimension that is less than the HDD form factor. Accordingly, the volume of space between the HDD form factor height and the SSD height is beneficially occupied by the cooling means. The storage system can be then be used as a direct replacement for HDD as it can fit within HDD bays configured for the standardized HDD form factor.

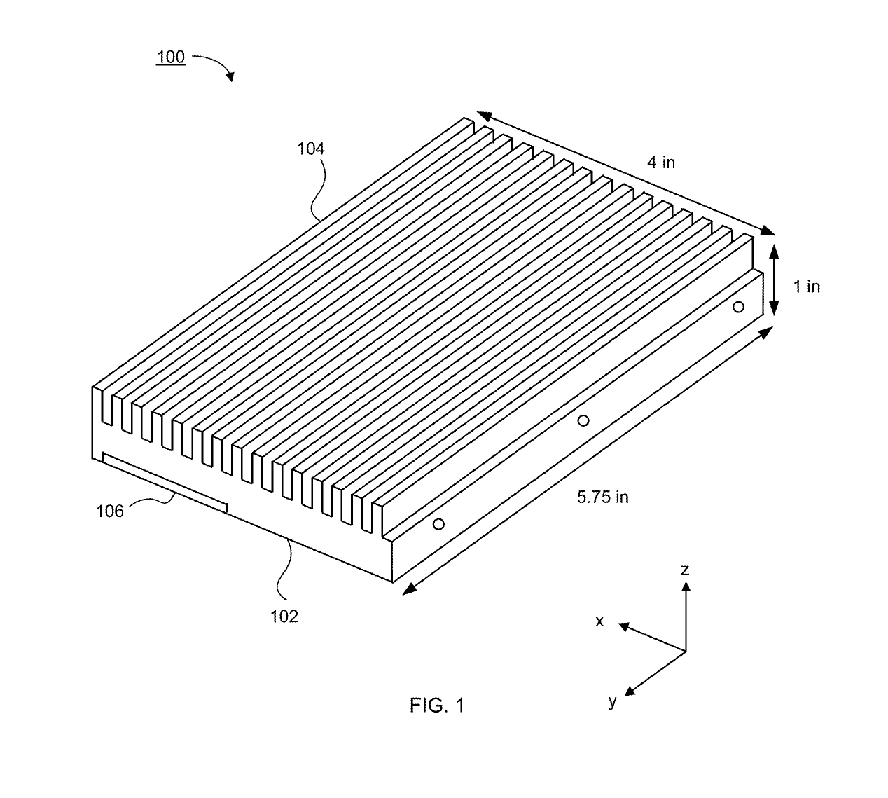

FIG. 1 is a block diagram of a storage system 100 according to an embodiment of the present disclosure. The storage system 100 has a form factor that allows it to fit within any pre-defined sized bay, such as standardized HDD bays of a computing device (not shown). In the presently shown embodiment, the storage system 100 is sized according to the pre-defined sized form factor of a standard 3.5 inch HDD form factor. The storage system 100 form factor has width, length and height dimensions extending respectively in the x-axis, y-axis and z-axis directions shown in FIG. 1. The storage system 100 comprises an SSD 102 and cooling means, shown as heat sink 104. The SSD 102 houses memory chip packages mounted to a PCB (not shown), which generate heat during operation. In one embodiment, the SSD 102 is made of a rigid material that has a high level of heat conductivity, such as aluminum for example. A face of SSD 102 includes an opening for placement of a physical host interface 106, such as a SATA interface for example. Any type of interface can be used to accommodate the specific application of the storage system 100. While not shown in FIG. 1, the underside of the body of SSD 102 can be a hollow cavity shaped to receive the PCB having the host interface 106. Therefore, the PCB can be inserted into the cavity and retained in place through any suitable means, including bonding or through screws by example. Alternately, the underside of SSD 102 can be closed, and the opposite face to the one having host interface 106 can have an opening to allow for insertion of the PCB into the cavity of the SSD 102 body. This opening can be closed with a face plate to retain the PCB inside SSD 102.

The heat sink 104 of the present embodiment is integrated with the body of the SSD 102, and is thereby thermally coupled to the heat-generating components as well as the body of SSD 102. For example, the unitary body of the SSD 102 and heat sink 104 can be a machined piece of metal such as aluminum, or it can be molded as a unitary body. In this embodiment the heat sink 102 comprises fins of any predetermined thickness projecting away from the SSD 102. The fins provide a large surface area exposed to the air, thereby allowing for effective dissipation of heat generated by SSD 102. Therefore any heat generated by components of the SSD 102 is conducted through the body of SSD 102 to the heat sink 102, to minimize heating of other components of SSD 102.

The SSD 102 of FIG. 1 can have x and y dimensions matching that of the 3.5 inch HDD form factor. The z dimension (height) of SSD 102 is just a portion of the 3.5 inch HDD form factor height, and in the present embodiment, can extend from the bottom surface to the junction where the fins of the heat sink 104 begin to project away from the SSD 102. If the z dimension of SSD 102 is minimized, then the height of the fins of heat sink 104 can be maximized. In this embodiment, each fin can be considered a separate cooling means thermally coupled to the SSD 102 and to the components housed by SSD 102. As used herein, the term “thermally coupled” refers to the placement of the cooling means such that the cooling means conducts heat away from any components of the SSD while in operation.

In the embodiment of FIG. 1, the heat sink 104 is shown with one specific configuration. Alternate configurations of heat sink 104 include a sheet of thermally conductive material, which can include a plurality of fins extending therefrom. The fins of heat sink 104 may be arranged in any suitable configuration, for example they may be parallel to one another, flared or formed as pillars. Generally, heat sink 104 is a passive cooling means that effectively extends the surface area exposed to the ambient environment of the storage system 100 to facilitate heat dissipation of the SSD 102, and any geometric configuration of the fins and materials that achieves this desired result can be used.

While the embodiment of FIG. 1 shows a heat sink 104 as an example cooling means, other types of cooling means can be used provided they are dimensioned to fit within the standard HDD form factor when thermally coupled to SSD 102. For example, the cooling means can include a cooling pipe, a fan or a combination thereof. Other types of cooling means include systems which circulate a coolant to the SSD 102 in order to remove heat therefrom.

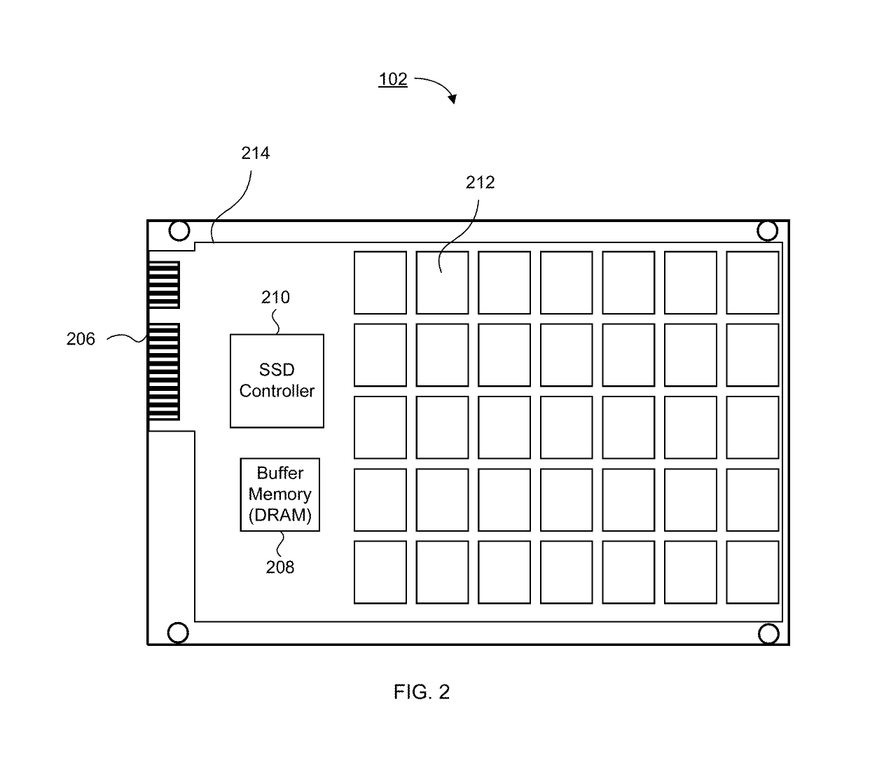

As previously discussed for the embodiment of FIG. 1, the SSD 102 includes a PCB having mounted thereon memory devices and other required electronic components. FIG. 2 is a schematic showing a top down view of the contents of SSD 102 of FIG. 1 when a top cover portion of the SSD 102 body is cut away. SSD 102 includes a PCB 214 shaped to fit within the body of SSD 102. The PCB 214 has a host interface connector 206 for connecting the storage system 100 to the computing device, also referred to as a host system, for facilitating the exchange of information between the storage system 100 and the host system. The connector 206 is an interface that uses a connection interface standard, for example, a serial advanced technology attachment (SATA) standard, serial SCSI, IDE, USB, PCIe or Thunderbolt interface. The connector 206 is disposed at an end of the PCB 214 such that when the storage system 100 is installed in a housing or bay of the computer device the connector is exposed via an opening in the SSD 102 housing.

Mounted to PCB 214 is a buffer memory 208, a controller 210, and a plurality of memory devices 212. The memory devices 212 may be non-volatile memory devices, such as for example NAND or NOR type flash memory devices, where each memory device 212 is shown as a packaged device which may contain several memory dies inside. While the previously mentioned flash memory is commonly used, any suitable non-volatile or volatile memory devices can be used. Techniques are known in the art for interconnecting and controlling multiple memory devices together for the purposes of transparently presenting a single mass storage device to the host system. The memory controller 210 is configured to control and manage the memory devices 212 in this manner. The buffer memory 208 may be in the form of RAM, but any suitable buffer memory may be used.

Those skilled in the art will appreciate that memory controller 210, buffer memory 208 and the memory devices 212 generate heat in operation. In one embodiment of the present disclosure, the cavity of SSD 102 for housing PCB 102 can be precisely sized in the height dimension such that the packages of memory controller 210, the buffer memory 208 and the memory devices 212 are in contact with the internal body of SSD 102, or at least in very close proximity to the internal body of SSD 102. Such an arrangement will improve thermal coupling between the packages of the devices mounted to PCB 214 and the body of SSD 102. The transferred heat can then be dissipated through the heat sink 104 that is thermally coupled to the SSD 102. This minimization of the SSD 102 height thereby allows for maximization of the difference in height spacing between HDD form factor height and the height of the SSD 102. Accordingly, the heat sink 104 dimensions, such as fin height, can be maximized. For alternate embodiments, this spacing may allow for use of alternate cooling means to be used with SSD 102. As will be discussed later, it is not necessary to fabricate the SSD 102 body with such precision, as different PCB's and devices mounted thereon may have different height profiles from each other.

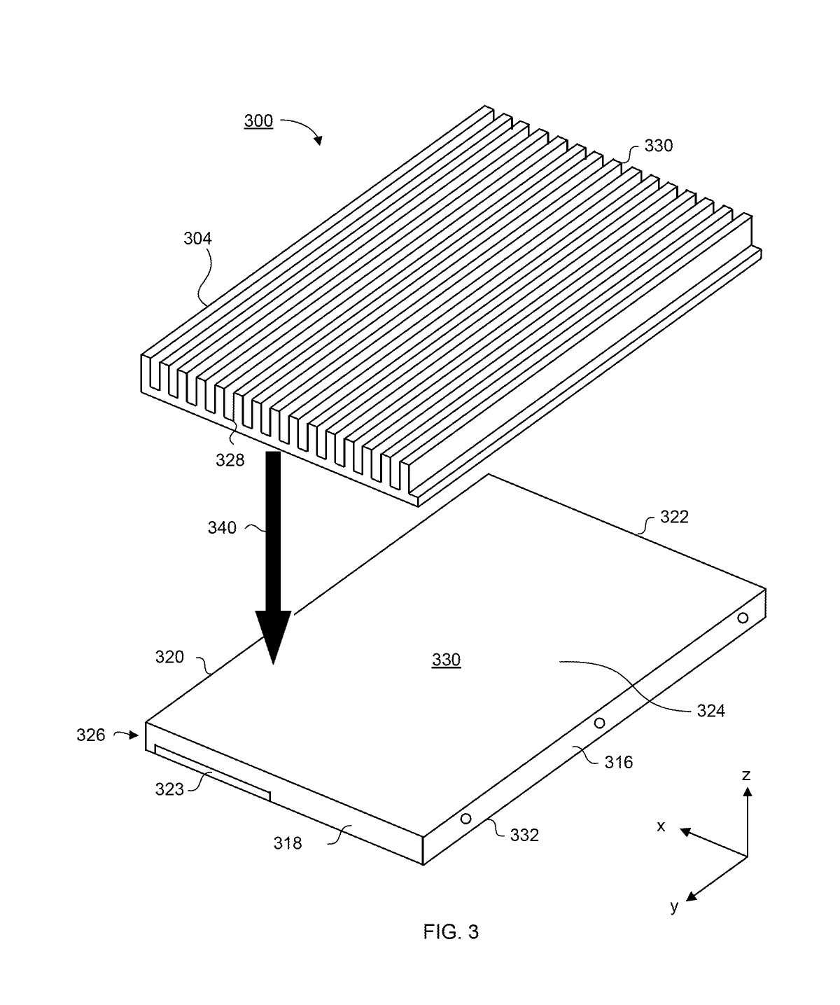

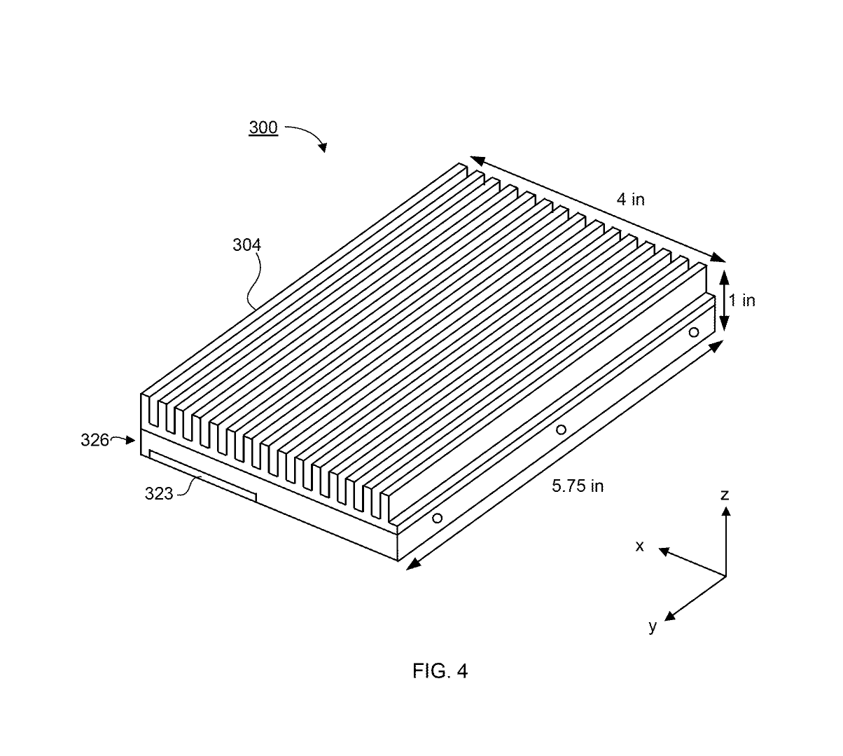

The storage system 100 of FIG. 1 is one embodiment where the SSD 102 and the cooling means are integrated with each other in a unitary structure, such that there is no clear delineation between the SSD 102 and the heat sink 104. FIGS. 3 and 4 illustrate a modular configuration according to an alternate embodiment of the disclosure, where the SSD and the cooling means are formed as separate components which can be attached to each other such that the combined components fit within the standard HDD form factor.

FIGS. 3 and 4 illustrate an alternate embodiment of the storage system 100 of FIG. 1. FIG. 3 is an exploded view of a storage system 300. In this embodiment, the storage system 300 includes an SSD 326 and a cooling means 304, shown as a heat sink. Housed within the SSD 326 is a PCB with memory devices as shown in FIG. 2. The PCB is supported on a base 332, which is a bottom of the SSD 326 in the orientation shown in FIG. 3. The base 332 can be a fully enclosed base, or partially enclosed where a surface of the PCB is exposed. The base 332 has sidewalls 316, 318, 320 and 322 extending therefrom, and a top cover 324 connected to the sidewalls. An opening 323 in sidewall 318 is provided for access to the host interface of SSD 326. The base 332, sidewalls 316, 318, 320 and 322 and top cover 324 together form a case of SSD 326 which encloses the PCB. The case of SSD 326 can be constructed by any means, and has width and length dimensions in the x and y directions of FIG. 3, respectively, matching those of the standardized HDD form factor. The height dimension of SSD 326 extends in the z direction of FIG. 3.

The heat sink 304 comprises a plate 328 of thermally conductive material which transfers the heat generated by the components of the SSD away from the PCB and the SSD 326. In the present embodiment, the plate 328 is dimensioned to have width and length dimensions in the x and y directions of FIG. 3, respectively, matching those of the standardized HDD form factor. The bottom surface of the heat sink 304 is placed in thermal contact with the upper surface 330 of the top cover 324 of the SSD 326, as illustrated by arrow 340. This can be done through direct contact, or through indirect contact where an intermediate thermal conducting material is placed between the top cover 324 and the bottom of heat sink 304. To further facilitate the transfer of heat away from the PCB or to the surrounding atmosphere, the plate 328 is provided with fins 330 to provide a larger surface area to the surrounding environment. The fins can be for example, louvered fins and have any geometric or structural configuration for facilitating heat dissipation. In the presently shown embodiment, the plate 328 can be dimensioned to have width and length dimensions smaller than that of the top cover 324 of SSD 326.

FIG. 4 is a block diagram showing the assembled storage system 300 of FIG. 3. The case 326 enclosing the PCB is fastened to the heat sink 304. The dimensions of a standard 3.5 inch HDD form factor are shown in FIG. 4, and it can be appreciated that the storage system 300 of this embodiment clearly maintains these dimensions. The storage system may be fastened using thermal tape, glue, adhesive bolts, mechanical clips, other mechanical structure or welding. The storage system of this embodiment may be modular, allowing for replacement of either the SSD 326 or the heat sink 304 if desired.

In the present embodiment, the heat sink 304, comprising the thermally conductive plate and fins, is substantially formed to cover the entire upper surface of the SSD 326. The heat sink 304 may be formed of metal or other material exhibiting a high thermal conductivity coefficient such as for example aluminum or an aluminum alloy. Consequently, the components of the SSD and the heat sink are thermally coupled and the heat absorbed from the heat generating components, for example the memory devices 212, the buffer memory 208 or the memory controller 210, can be rapidly and uniformly distributed over a large area and conducted away from the SSD 326. However, the storage system is not limited to having a heat sink on the upper surface and it is possible to have the heat sink or other cooling means fastened and thermally connected to the bottom surface of the SSD, such that heat generated by the SSD is dissipated away from the SSD 326.

To further improve cooling or heat dissipation, in certain embodiments thermal transfer medium may be adhered to the PCB and fill some of the space in the cavity of the SSD body. More specifically, the thermal transfer medium fills space between the devices of the PCB and an inner surface of the SSD body cavity. This results in in the reduction of air gaps and an increase in thermal conductivity from the devices of the PCB to the SSD body. Thus, the thermal transfer medium cooperates with the cooling means for transferring heat away from the SSD.

As used herein the term “thermal transfer medium” refers to any medium that is capable of transferring heat. Generally, the transfer of heat occurs between heat-generating memory devices or controllers and heat sinks or other cooling devices. The thermal transfer medium may be, for example, thermally conductive adhesive tape, thermally conductive grease, thermally conductive acrylic interface pads, thermally conductive silicone interface pads, or thermally conductive epoxy adhesives. The thermal transfer medium has greater thermal conductivity than air. Therefore thermal coupling between the devices and the cooling means of the storage system is improved by filling air-gaps between the device packages and the SSD cavity body with the thermal transfer medium. Furthermore, the thermal transfer medium compensates for imperfectly smooth surfaces of the device packages which impedes maximum thermal coupling efficiency.

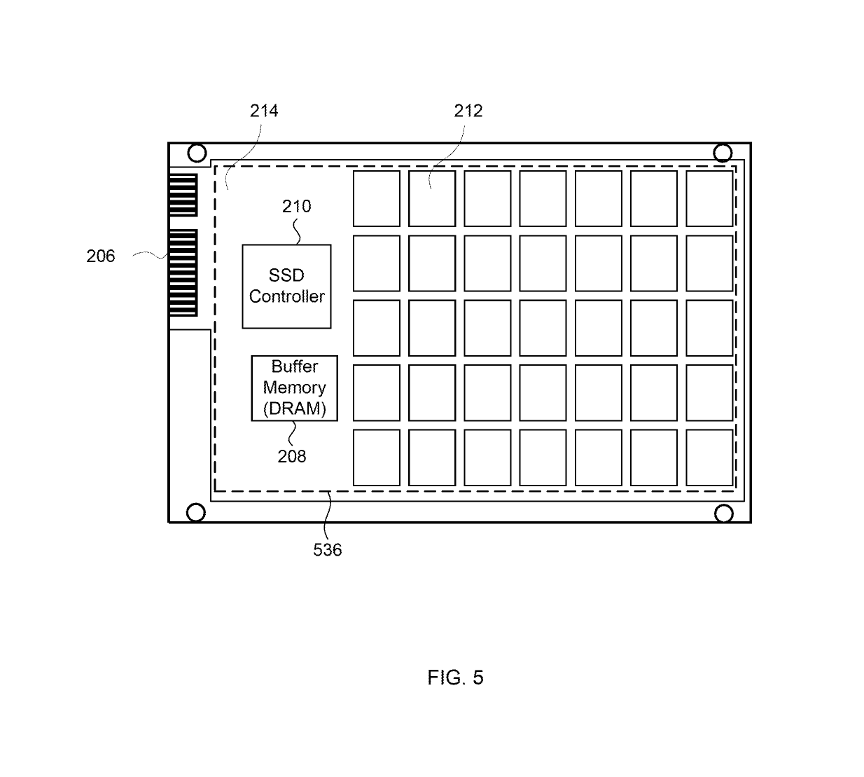

FIG. 5 is a similar schematic to that of FIG. 2, except that the embodiment of FIG. 5 shows the inclusion of a thermal transfer medium 536 shown by the dashed box outline, contacting at least the components mounted to PCB 214. In the presently shown example, the thermal transfer medium 536 can include thermal tape or thermal grease, which is adhered to the buffer memory 208, the SSD controller 210, and the memory devices 212, and makes contact with the internal cavity wall of the SSD. The SSD of FIG. 5 can be used with the storage system embodiments of FIGS. 1 and 4.

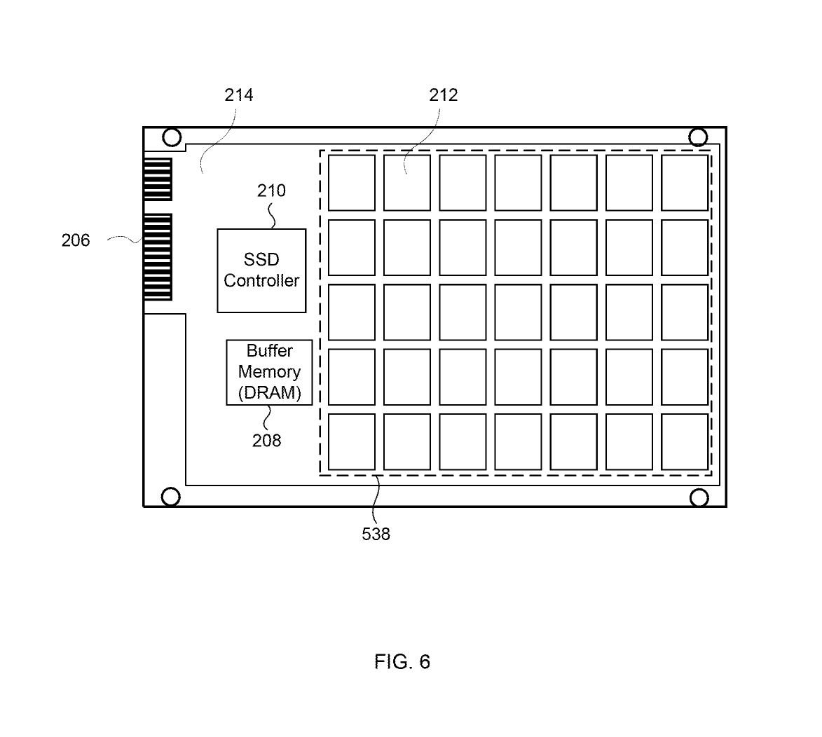

FIG. 6 illustrates an alternate embodiment based on the embodiment of FIG. 5. In the embodiment of FIG. 6, thermal transfer medium 538 is adhered to only the memory devices 212. The SSD of FIG. 5 can be used with the storage system embodiments of FIGS. 1 and 4.

To further improve heat dissipation, the cooling means may comprise at least one fan, such as a low profile fan. The air flow generated during the running of the fan passes through the gaps between the heat sink fins to improve the rate of heat dissipation. Many suitable arrangements of the fan and the fins are possible, provided the combination when attached to the SSD fits within the standard HDD form factor.

In the previously shown embodiment of FIG. 3, the SSD 326 includes a top cover 324. In an alternate embodiment, the top cover 324 is omitted to facilitate installation of the PCB in the open cavity of the SSD 326 body. Then a thermal transfer medium can be easily applied to the packages of the devices mounted to the PCB, and the heat sink 304 can be attached to cover the opening of the body of SSD 326 while making contact with the thermal transfer medium.

The previously disclosed embodiments illustrate a memory system composed of an SSD with a cooling means, having a form factor that is no greater than a pre-defined size form factor, such as a standardized HDD form factor by example. This allows the memory system of the present embodiments to be used as a replacement for the traditional HDD in applications where the space requirements are constrained to the standardized HDD form factor. Therefore no modifications to the pre-defined size form factor by the industry is required.

In the embodiments described above, the device elements and circuits are connected to each other as shown in the figures, for the sake of simplicity. In practical applications of the present disclosure, elements, circuits, etc. may be connected directly to each other. As well, elements, circuits etc. may be connected indirectly to each other through other elements, circuits, etc., necessary for operation of devices and apparatus. Thus, in actual configuration, the circuit elements and circuits are directly or indirectly coupled with or connected to each other.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding.

The above-described embodiments are intended to be examples only. Alterations, modifications and variations can be effected to the particular embodiments by those of skill in the art without departing from the scope, which is defined solely by the claims appended hereto.

1. A storage system for a computing device, the storage system comprising:
a solid state drive (SSD); having a length and a width corresponding to a pre-defined sized hard disk drive (HDD) form factor; and
a cooling device thermally coupled to the SSD, the SSD in combination with the cooling device being dimensioned to fit within the pre-defined sized hard disk drive (HDD) form factor.

2. The storage system of claim 1, wherein the form factor of the SSD in combination with the cooling device is defined by orthogonal dimensions a, b and c, that are less than or equal to the pre-defined sized HDD form factor orthogonal dimensions x, y and z, respectively.

3. The storage system of claim 1, wherein the SSD includes
a printed circuit board (PCB);
a host interface connector connected to the PCB;
a buffer memory mounted to the PCB;
a controller mounted to the PCB; and
at least one memory storage device mounted to the PCB.

4. The storage system of claim 3, wherein the SSD and the cooling device are integrated with each other as a single unit.

5. The storage system of claim 4, further comprising a thermal transfer medium contacting the at least one memory device and an inner surface of the SSD, the thermal transfer medium cooperating with the cooling device for transferring heat away from the at least one memory device.

6. The storage system of claim 3, wherein the SSD includes a base for supporting the PCB.

7. The storage system of claim 6, wherein the SSD includes at least two sidewalls extending substantially perpendicularly from the base and a cover connected to the sidewalls, the base, the sidewalls and the cover forming a case for housing the PCB.

8. The storage system of claim 7, further comprising a thermal transfer medium contacting the at least one memory device and the cover of the SSD, the thermal transfer medium cooperating with the cooling device for transferring heat away from the at least one memory device.

9. The storage system of claim 7, wherein the cooling device is fastened to the cover of the SSD.

10. The storage system of claim 9, further including a thermal transfer medium between the cover and the cooling device.

11. The storage system of claim 10, wherein the thermal transfer medium comprises thermal tape or thermal grease.

12. The storage system of claim 6, wherein the SSD includes at least two sidewalls extending substantially perpendicularly from the base to form an open cavity for containing the PCB.

13. The storage system of claim 12, wherein the cooling device is fastened to the at least two sidewalls of the SSD to cover the open cavity.

14. The storage system of claim 13, further comprising a thermal transfer medium contacting the at least one memory device and the cooling device, the thermal transfer medium cooperating with the cooling device for transferring heat away from the at least one memory device.

15. The storage system of claim 1, wherein the cooling device includes a heat sink.

16. The storage system of claim 15, wherein the cooling device further comprises a fan mounted to the heat sink.

17. The storage system of claim 15, wherein the heat sink includes a plate of thermally conductive material and a plurality of fins extending from the plate, for dissipating heat away from the SSD.

18. The storage system of claim 1, wherein the pre-defined sized HDD form factor is a 3.5 inch form factor.

19. The storage system of claim 1, wherein the pre-defined sized HDD form factor is a 2.5 inch form factor.

20. The storage system of claim 1, wherein the pre-defined sized HDD has an industry standard form factor which fits a standard sized compartment in a computing device.
